(19) United States
(12) Patent Application Publication
(10) Pub. No.: US 2010/0118008 A1
(43) Pub. Date: May 13, 2010

(54) COLOR PROCESSING APPARATUS, COLOR PROCESSING METHOD, AND STORAGE MEDIUM

(75) Inventor: Hirochika Matsuoka, Tokyo (JP)

Correspondence Address: COWAN LIEBOWITZ & LATMAN P.C.;JOHN J TORRENTE, 1133 AVE OF THE AMERICAS, NEW YORK, NY, 10036, US

(73) Assignee: CANON KABUSHIKI KAISHA, Tokyo (JP)

(21) Appl. No.: 12/604,499

(22) Filed: Oct. 23, 2009

(30) Foreign Application Priority Data
Nov. 10, 2008 (JP) 2008-287947

(51) Int. Cl. G09G 5/00; G09G 5/10

(52) U.S. Cl. 345/207; 345/690

(57) ABSTRACT

A color processing apparatus that creates a lookup table for performing a conversion process corresponding to ambient light comprises: an obtainment unit configured to obtain the illuminance of the ambient light and the device luminance of a destination device; a creation unit configured to create an adaptive luminance function from the illuminance of the ambient light and the device luminance; a setting unit configured to set an adaptive white luminance from a luminance value of grid point color data corresponding to a grid point in the lookup table, using the adaptive luminance function; a conversion unit configured to perform a conversion process on the grid point color data in accordance with a color appearance model, using the adaptive white luminance; and a saving unit configured to save the converted color data in the lookup table.

### BACKGROUND OF THE INVENTION

1. Field of the Invention

The present invention relates to a color processing apparatus, a color processing method, and a storage medium for reproducing an image in a device having a different range of luminance.

2. Description of the Related Art

Recent years have seen the dramatic advancement of image software technologies such as computer graphics (CG) technologies and display device technologies including high-luminance liquid crystal projectors, liquid crystal displays with broad color gamut compatible with Adobe color gamut, and so on. As a result of such advancement, it has become common to check digital images captured using a digital still camera (DSC) or digital images created through CG modeling on various types of display devices, such as displays, projectors, and the like.

In order to check images in this manner, it is desirable for the appearance of the images to be uniform regardless of the type of display device. Here, the appearance of images in a CG workflow shall be described as an example.

Generally speaking, CG designers perform their designs while checking the color, tone, and the like of an image in, for example, an sRGB monitor. However, when making a presentation or the like after the design process, the images are often displayed using a large-screen liquid crystal television, a liquid crystal projector, or the like that has different luminance/color reproduction properties than the sRGB monitor. There is therefore demand for the appearance of images in sRGB monitors to be faithfully reproduced in such large-screen liquid crystal televisions, liquid crystal projectors, and so on in order to present the designer's images accurately during presentations.

Two techniques for meeting such image reproduction demands are known: one is color matching, which faithfully reproduces the appearance of color, and the other is tone correction, which faithfully reproduces the appearance of tone. These techniques shall be described hereinafter.

First, color matching shall be described. Color matching is a technique for achieving perceptual uniformity in image color reproduction among devices having different color gamuts. The Color Management System (CMS), which uses the ICC color profile specified by the International Color Consortium (ICC), is known as one example. In this system, a device-independent Profile Connection Space (PCS) for performing color matching is first designed. Color management is then implemented using a source profile, which specifies color conversion from the device color space to the PCS, and a destination profile, which specifies color conversion from the PCS to the device color space. Note that “PCS” is also sometimes called a “hub color space”.

In color matching, color processing is executed by performing a conversion process such as that described hereinafter based on the above two types of color profiles. First, color signal values in the device color space compatible with the input device that has inputted the image are converted to color signal values in the PCS using the source profile. After this, the color signals are further converted into a color signal in a device color space compatible with output device using the destination profile.

Such color matching can be widely and flexibly applied to monitor-printer systems used in CG, proof systems used in DTP, or the like. For example, with a presentation using CG such as that described above, a color profile that describes the properties of a monitor may be specified as the source profile, and a color profile that describes the properties of a printer may be specified as the destination profile. Through this, it is possible to achieve perceptual uniformity between a desired image and the image thereof as outputted by a printer.

It should be further noted that the ICC color profile is a format that is also compliant with CIECAM97s (CAM, or Color Appearance Model) and the like, which is a color appearance model issued by the International Commission on Illumination (CIE). Therefore, using the ICC color profile makes it possible to construct a CMS that is compliant with changes in visual adaptation states imparted by observation environments.

Next, tone correction shall be described. Tone correction is a technique for achieving perceptual uniformity in image tone reproduction among devices having different dynamic ranges. iCAM06 (see, for example, Non-Patent Document 1: Kuang, J., Johnson, G. M., Fairchild M. D. “iCAM06: A refined image appearance model for HDR image rendering”. Journal of Visual Communication, 2007) and Local Contrast Range Transform (LCRT; see, for example, Non-Patent Document 2: Yusuke Monobe, Haruo Yamashita, Toshiharu Kurosawa, Hiroaki Kotera. “Dynamic Range Compression Preserving Local Image Contrast for Digital Video Camera”. IEEE Transaction on Consumer Electronics, Vol 51, No. 1, February 2005) are known as examples thereof. Although these techniques have different technical approaches to tone reproduction, both are tone compression techniques involving visual local adaptation. Therefore, these techniques are capable of faithfully reproducing the sense of tone of images or objects having high luminance, such as occurs when, for example, such images or objects are observed out of doors, in a device having a comparatively low luminance, such as a monitor, a printer, or the like.

However, both of the aforementioned conventional color matching and tone correction techniques have their respective advantages and disadvantages.

Color matching is particularly useful for faithfully reproducing the sense of chromaticity of colors, and as it is a conversion that does not depend on the image structure, it can be implemented as a lookup table (LUT). Implementation as an LUT enables the acceleration of processing through approximation using interpolation calculations, which is a significant advantage in displays, where high-speed color conversion is required when displaying video.

However, because color matching does not take into consideration the illuminance of lighting, the display luminance, or the like, it is not capable of matching the sense of tone or the sense of brightness among devices whose ranges of luminance differ greatly or among environments in which the illuminance differs greatly.

Meanwhile, tone correction such as iCAM06 is useful in matching the sense of tone or the sense of brightness among devices whose ranges of luminance differ greatly. However, in tone correction, investigations into color gamut compression techniques, partial adaptation techniques, and the like has not made sufficient progress; therefore, not only do issues with respect to the faithful reproduction of the sense of chromaticity of colors remain, but there is also a problem in that tone correction processing is difficult to perform in real time in applications such as video display due to the high amount of processing. In addition, because the conversion depends on the image structure, tone correction cannot be implemented as an LUT; therefore, the tone correction processing cannot be accelerated through approximation using interpolation computations, contrary to the color matching technique. Furthermore, in cases such as where color gamut compression techniques are introduced into the tone correction, the processing is carried out on a pixel-by-pixel basis as a result, leading to the possibility of an extremely large increase in the processing cost.

### SUMMARY OF THE INVENTION

According to one aspect of the invention, a color processing apparatus that creates a lookup table for performing a conversion process corresponding to ambient light comprises: an obtainment unit configured to obtain the illuminance of the ambient light and the device luminance of a destination device; a creation unit configured to create an adaptive luminance function from the illuminance of the ambient light and the device luminance; a setting unit configured to set an adaptive white luminance from a luminance value of grid point color data corresponding to a grid point in the lookup table, using the adaptive luminance function; a conversion unit configured to perform a conversion process on the grid point color data in accordance with a color appearance model, using the adaptive white luminance; and a saving unit configured to save the converted color data in the lookup table.

Further features of the present invention will become apparent from the following description of exemplary embodiments (with reference to the attached drawings).

### BRIEF DESCRIPTION OF THE DRAWINGS

FIG. 1 is a block diagram illustrating the configuration of an image processing system according to a first embodiment of the present invention.

FIG. 2 is a diagram illustrating an example of an application window for video processing settings for a liquid crystal projector according to the first embodiment.

FIG. 3 is a block diagram illustrating the configuration of a liquid crystal projector according to the first embodiment.

FIG. 4 is a flowchart illustrating a color-correction 3D-LUT generation process according to the first embodiment.

FIG. 5 is a diagram illustrating the data structure of a Dst device profile according to the first embodiment.

FIGS. 6A and 6B are diagrams illustrating the data structure of a Dst CAM profile according to the first embodiment.

FIG. 7 is a flowchart illustrating a Dst CAM profile generation process according to the first embodiment.

FIG. 8 is a flowchart illustrating an adaptive luminance function calculation process according to the first embodiment.

FIGS. 9A, 9B, 9C, 9D, 9E, and 9F are diagrams illustrating examples of luminance calculation functions for each of multiple representative environments according to the first embodiment.

FIG. 10 is a flowchart illustrating a 3D-LUT creation process through color matching according to the first embodiment.

FIG. 11 is a block diagram schematically illustrating an outline of 3D-LUT generation according to the first embodiment.

FIG. 12 is a flowchart illustrating a color-correction 3D-LUT generation process according to a second embodiment.

FIG. 13 is a flowchart illustrating a process for creating a new Dst device profile according to the second embodiment.

FIG. 14 is a flowchart illustrating a 3D-LUT creation process using a color matching process according to the second embodiment.

FIG. 15 is a block diagram schematically illustrating an outline of 3D-LUT generation according to the second embodiment.

FIG. 16 is a block diagram illustrating the configuration of an image processing system according to a third embodiment.

FIG. 17 is a diagram illustrating an example of a 3D-LUT setting application window according to the third embodiment.

FIG. 18 is a flowchart illustrating a 3D-LUT generation process according to the third embodiment.

FIG. 19 is a flowchart illustrating a 3D-LUT creation process using a color matching process according to the third embodiment.

### DESCRIPTION OF THE EMBODIMENTS

### First Embodiment

### Apparatus Configuration

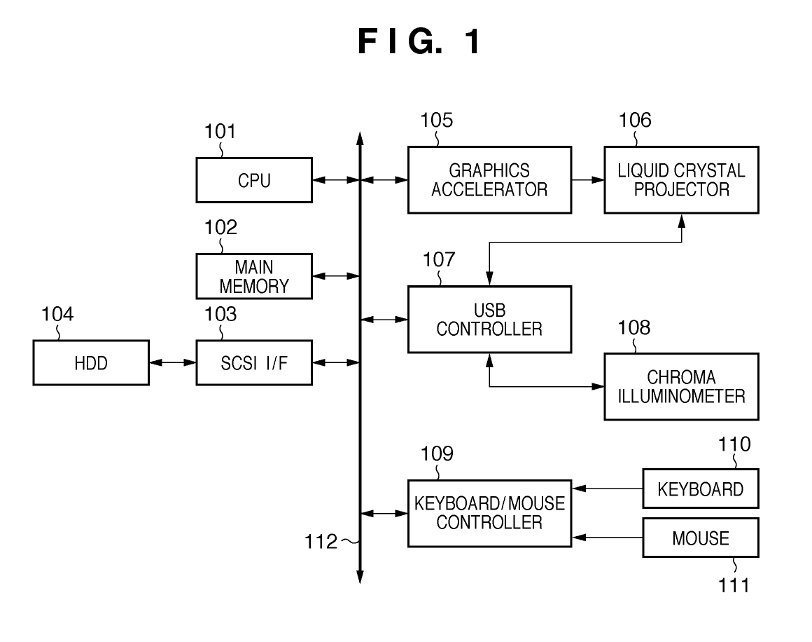

FIG. 1 is a block diagram illustrating the configuration of a color processing apparatus according to the present embodiment. The color processing apparatus illustrated in FIG. 1 according to the present embodiment is configured of what is known as a computer system, and image display software is executed thereby. The operations of this image display software shall be described hereinafter.

In FIG. 1, 101 represents a CPU that controls the overall processing of the apparatus, and 102 represents a main memory used as a work area of the CPU 101 and as a storage region. 104 represents a hard disk drive (HDD), which is connected to a PCI bus 112 via a SCSI I/F 103. Hereinafter, the hard disk drive, including an installed HD, shall be called an HDD 104. 105 is a graphics accelerator, which controls the projected images supplied to a liquid crystal projector 106. 108 is a chroma illuminometer, which obtains the illuminance and chromaticity of the ambient light, as shall be described later. The liquid crystal projector 106 and the chroma illuminometer 108 are connected to the PCI bus 112 via a USB controller 107. 110 is a keyboard and 111 is a mouse, which are connected to the PCI bus 112 via a keyboard/mouse controller 109.

In the configuration illustrated in FIG. 1, first, image display software stored in the HDD 104 is executed through processing performed by the CPU 101. Then, in the event of a user instruction, a JPEG image, an H.264 image, or the like stored in the HDD 104 is loaded, and that image is projected/displayed by the liquid crystal projector 106 via the graphics accelerator 105, through processing performed by the CPU 101. In the present embodiment, the appearance of that same image as displayed in a specific sRGB monitor (not shown) is faithfully reproduced in the appearance of the projected image in the liquid crystal projector 106 observed by the user.

Generally, the range of luminance of an sRGB monitor is lower than the range of luminance of the liquid crystal projector 106. In the present embodiment, it is necessary for a user to measure the ambient light in advance and make video processing settings in the liquid crystal projector 106 in order to ensure that the projected image of the liquid crystal projector 106 is appropriate, or in other words, in order to faithfully reproduce the appearance of the image as displayed in a specific sRGB monitor. Hereinafter, these video processing settings of the liquid crystal projector 106 shall be described using FIG. 1.

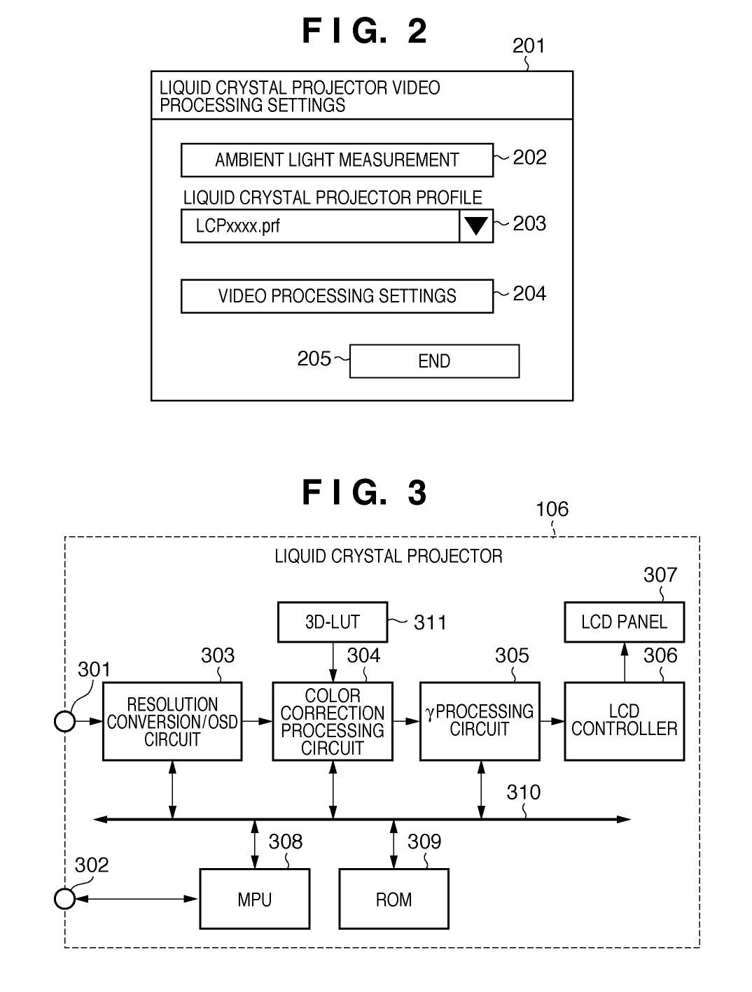

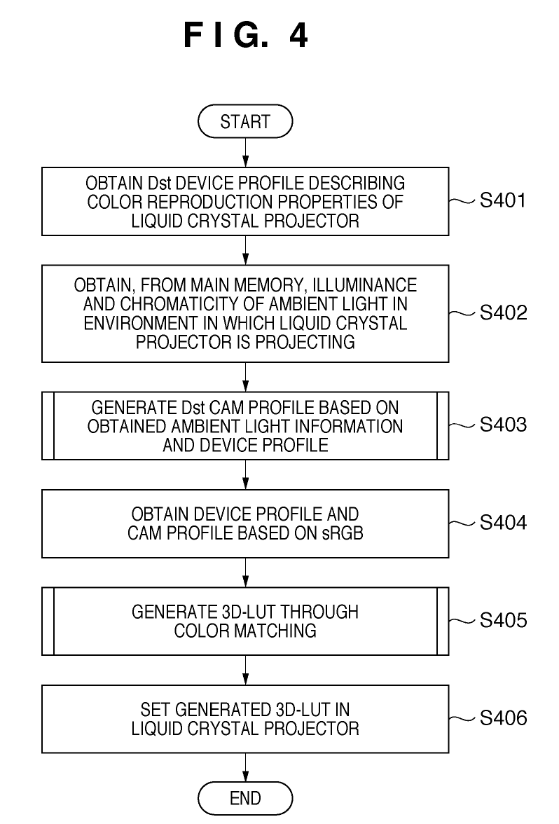

In the configuration illustrated in FIG. 1, a liquid crystal projector video processing settings application stored in the HDD 104 is executed by the CPU 101 in response to a user instruction. After this, an application window 201 (hereinafter, called simply a “window”) as shown in FIG. 2 is projected/displayed by the liquid crystal projector 106 via the graphics accelerator 105, based on a command to render the application window provided by the CPU 101. Note that the liquid crystal projector 106 has an OSD (On-Screen Display) function, making it possible for the user to make operational inputs. The user first presses an ambient light measurement button 202 in this window 201, thereby instructing the measurement of the ambient light in the environment in which the liquid crystal projector is projecting. Upon doing so, the CPU 101 obtains the illuminance and chromaticity of the ambient light from the chroma illuminometer 108 via the USB controller 107, and stores that illuminance and chromaticity in the main memory 102. Next, the user specifies, from a pull-down list 203 in the window 201, the device profile in which the device color reproduction properties of the liquid crystal projector 106 are denoted, and then presses a video processing settings button 204. Upon doing so, a color-correction three-dimensional lookup table (3D-LUT) is generated in accordance with the flowchart illustrated in FIG. 4, which shall be described later, and is set in the liquid crystal projector 106 via the USB controller 107.

Next, the video processing performed within the liquid crystal projector 106 shall be described. FIG. 3 is a block diagram illustrating the configuration of the liquid crystal projector 106. The internal configuration of the liquid crystal projector 106 can be roughly divided into two groups: an image processing circuit group that performs image processing on an inputted video signal, including 303 (a resolution conversion/OSD circuit) to 307 (an LCD panel); and a control circuit group, including an MPU 308 and a ROM 309, that controls the image processing circuit group. Note that 301 represents a video signal input terminal, which is connected to the graphics accelerator 105. 302, meanwhile, represents a USB terminal, which is connected to the USB controller 107.

A video signal inputted through the video signal input terminal 301 enters the image processing circuit group, where it is first converted, by the resolution conversion/OSD circuit 303, into an image signal of a resolution suitable for the LCD panel 307. The post-resolution conversion image then undergoes color conversion performed by a color correction processing circuit 304 using a 3D-LUT 311, undergoes γ conversion performed by a γ processing circuit 305 for correcting the V-T properties of the LCD panel 307, and is then inputted into an LCD controller 306. The LCD controller 306 generates a control signal for driving the LCD panel 307 in response to the input thereinto. An image is then formed upon a screen by projecting light from a light source lamp (not shown) onto the LCD panel 307.

Meanwhile, the control circuit group performs various controls for operating the image processing circuit group in an appropriate manner. First, the MPU 308 reads out, from the ROM 309, various settings parameters for the image processing circuit group, from 303 (the resolution conversion/OSD circuit) to 306 (the LCD controller), and sets these parameters to each units as initialization operations performed when operating the liquid crystal projector 106. In addition, upon receiving a 3D-LUT setting command from the CPU 101 via the USB terminal 302, the MPU 308 issues an instruction to the image processing circuit group via a bus 310 to stop processing. After this, the received 3D-LUT is set as the 3D-LUT 311, capable of being referenced by the color correction processing circuit 304. Then, the MPU 308 provides another instruction to the image processing circuit group via the bus 310 to start the processing.

In the present embodiment, the 3D-LUT 311 referenced by the color correction processing circuit 304 of the liquid crystal projector 106 is generated as appropriate so that the appearance of an image displayed in a specific sRGB monitor is faithfully reproduced when that image is projected/displayed.

3D-LUT Generation Process

Next, a process for generating the 3D-LUT 311 referenced by the color correction processing circuit 304 in the present embodiment shall be described using the flowchart in FIG. 4.

First, in step S401, the device profile describing the device color reproduction properties of the liquid crystal projector 106, specified by the user through the pull-down list 203 in the window 201 shown in FIG. 2, is obtained. The device profile of the liquid crystal projector 106 obtained here is the destination profile, and therefore shall be referred to hereinafter as the “Dst device profile”.

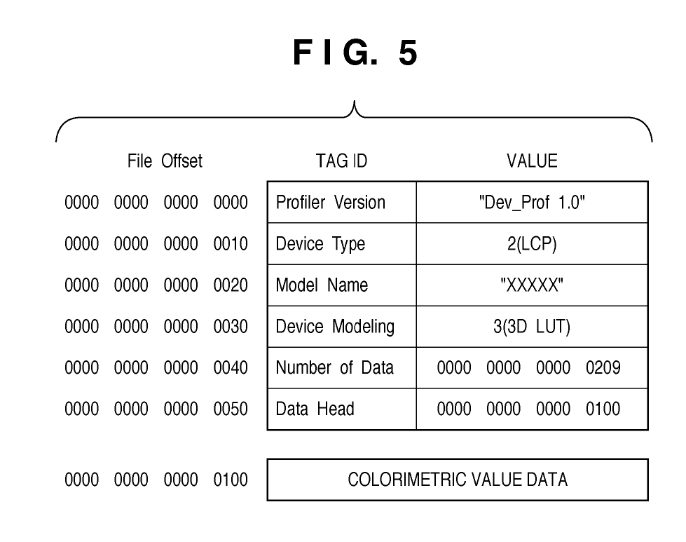

FIG. 5 illustrates the data structure of the Dst device profile. As shown in FIG. 5, the Dst device profile is composed of 4-byte tags, following 12-byte data strings, and colorimetric value data. Note that in FIG. 5, the numerical values on the left side express offset addresses within the file, and the tag ID in the center and the value on the right side express the details of the data actually denoted within the file. Here, the tag IDs are expressed as keywords in order to simplify the descriptions, but in actuality, the data denoted is a 4-byte value corresponding to the keywords.

Next, each of the tags in the Dst device profile illustrated in FIG. 5 shall be described in detail.

First, the tag ID “Profiler Version” indicates that the following information is a character string expressing the profile type and version. This tag is always placed at the start of the profile.

The tag ID “Device Type” indicates that the following information is the device type, where if the value denoted is 0, the device is a printer; if 1, a monitor; if 2, an LCP (liquid crystal projector); if 3, a DSC (digital still camera); and if 4, a scanner.

The tag ID “Model Name” indicates that the following information is a character string expressing the model name.

The tag ID “Device Modeling” indicates that the following information is a model expression method for the device properties. If the value denoted is 0, the colorimetric value data following thereafter is a value based on a 3D-LUT; if 1, a γ matrix model; if 2, a three-dimensional polynomial model; and if 3, an sRGB conversion model. Note that the configuration of the 3D-LUT in the present embodiment is described in detail in the ICC Profile specifications issued by the ICC (International Color Consortium), and therefore descriptions thereof shall be omitted here.

The tag ID “Number of Data” indicates the total number of XYZ values described in the colorimetric value data. In the example shown in FIG. 5, the profile is based upon a 3D-LUT depending on the tag ID “Device Modeling”, and therefore 9 to the 3rd power is denoted as a hexadecimal, resulting in 2D9.

The tag ID “Data Head” indicates the starting address of the colorimetric value data description. The total number of this colorimetric data is denoted using single precision floating points, in X, Y, Z order.

When such a liquid crystal projector 106 device profile, or in other words, the Dst device profile as described thus far, is obtained, the illuminance and chromaticity of the ambient light in the environment in which the liquid crystal projector is projecting, stored in the main memory 102, is then obtained in step S402.

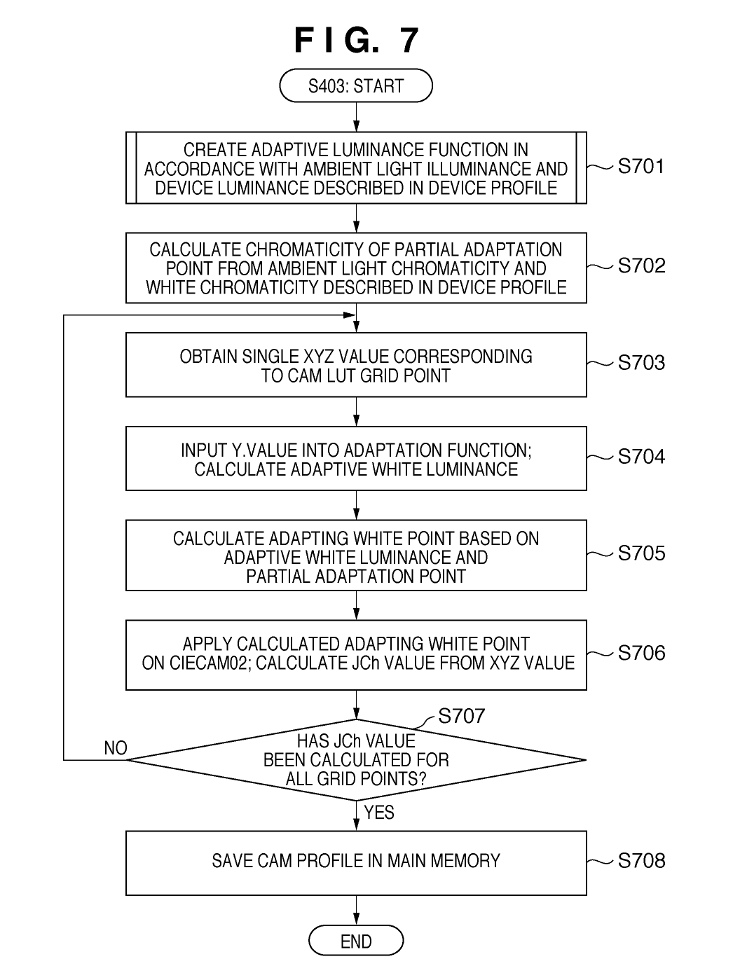

Then, in step S403, a CAM profile of the liquid crystal projector 106 is generated based on the Dst device profile information obtained in step S401 and the observed light information obtained in step S402. The “CAM profile” discussed here is a profile that specifies the Color Appearance Model of the liquid crystal projector 106. The CAM profile created here is a destination profile, and therefore shall be referred to as a “Dst CAM profile” hereinafter. Note that the process for generating the Dst CAM profile shall be described in detail using FIG. 7.

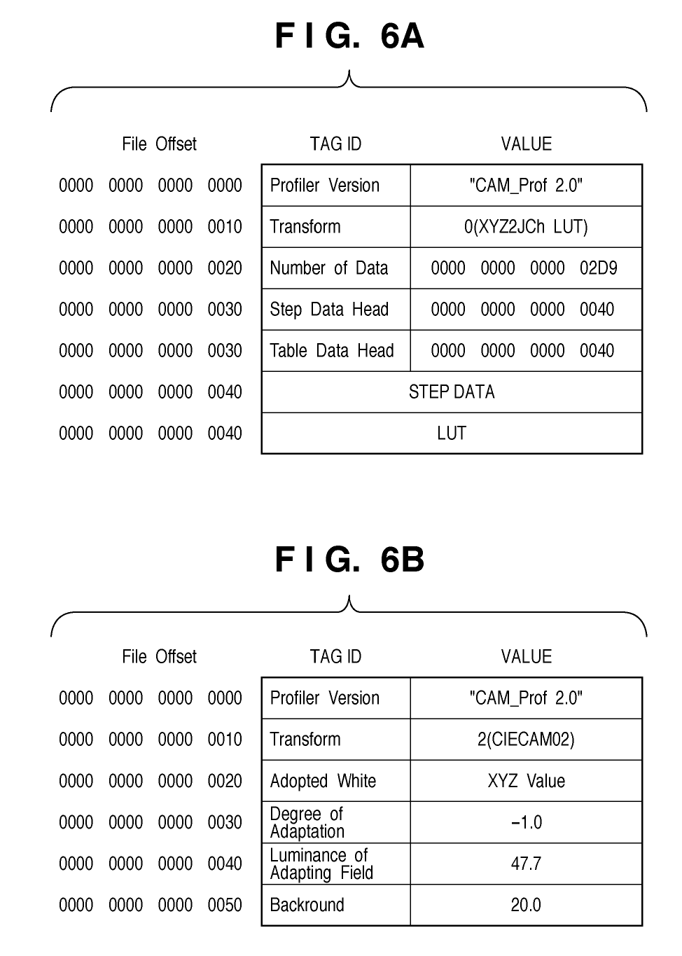

FIGS. 6A and 6B illustrate the data structure of the Dst CAM profile according to the present embodiment. As shown in FIGS. 6A and 6B, the Dst CAM profile is composed of 4-byte tags and following 12-byte data strings. Note that in FIGS. 6A and 6B, the numerical values on the left side express offset addresses within the file, and the tag ID in the center and the value on the right side express the details of the data actually denoted within the file. Here, the tag IDs are expressed as keywords in order to simplify the descriptions, but in actuality, the data denoted is a 4-byte value corresponding to the keywords.

The tags in the Dst CAM profile shall be described in detail hereinafter.

First, the tag ID “Profiler Version” indicates that the information following thereafter is a character string expressing the profile type and version. This tag is always placed at the start of the profile.

The tag ID “Transform” indicates that the following information is a format type in which XYZ values have been transformed to CIECAM02 color space coordinates. If the data is 0, the relationship for transforming from XYZ values to CIECAM02 color space coordinates is described in the profile using a 3D-LUT. If the data is 1, the relationship for transforming from CIECAM02 color space coordinates to XYZ values is described in the profile using a 3D-LUT. Meanwhile, if the data is 2, the relationship for transforming between XYZ values and CIECAM02 color space coordinates is defined in the profile using CIECAM02 appearance parameters.

FIG. 6A illustrates a profile example where the tag ID “Transform” is 0. In FIG. 6A, the tag ID “Number of Data” indicates the total number of XYZ values described in the colorimetric value data. The tag ID “Step Data Head” indicates the starting address of step descriptions (step data) of the 3D-LUT indicating the relationship for transforming from XYZ values to CIECAM02 color space coordinates. The step sizes in the X, Y, and Z axes are denoted from the starting address as the cubic root of the total number described in the tag ID “Number of Data”. The tag ID “Table Data Head” indicates the starting address of the table data descriptions (LUT data). CIECAM02 color space coordinates are denoted for the total number from the starting address through single precision floating points, in J, aC, bC order.

Note that a profile in which the tag ID “Transform” is 1 is identical to the profile in which the tag ID “Transform” is 0 as indicated above in FIG. 6A with the exception that JaCbC is replaced with XYZ, and therefore descriptions thereof shall be omitted.

FIG. 6B illustrates a profile example where the tag ID “Transform” is 2. In FIG. 6B, the tag ID “Adopted White” indicates that the following information is an adapted white point; the XYZ values of the adapted white point are denoted as a single precision floating points in X, Y, Z order. The tag ID “Degree of Adaptation” indicates that the following information is the percentage of incomplete adaptation, and is denoted as a single precision floating point. If this data is −1, the percentage of incomplete adaptation is calculated automatically. The tag ID “Luminance of Adapting Field” indicates that the following information is the luminance value of the adapting field, and is denoted as a single precision floating point. In general, a value of 20% of the average luminance value of the 2 degree field is denoted. The tag ID “Background” indicates that the following information is the background luminance, and a value relative to white is denoted as a single precision floating point. In general, 20 is denoted as a percentage of the average luminance value of the 10 degree field. Detailed descriptions thereof are provided in the CIECAM02 specification defined by the CIE, and therefore detailed descriptions shall be omitted here.

It is assumed in the present embodiment that in step S403, the Dst CAM profile is generated in LUT format, as shown in FIG. 6A.

Next, in step S404, the device profile and CAM profile corresponding to a specific sRGB monitor are obtained.

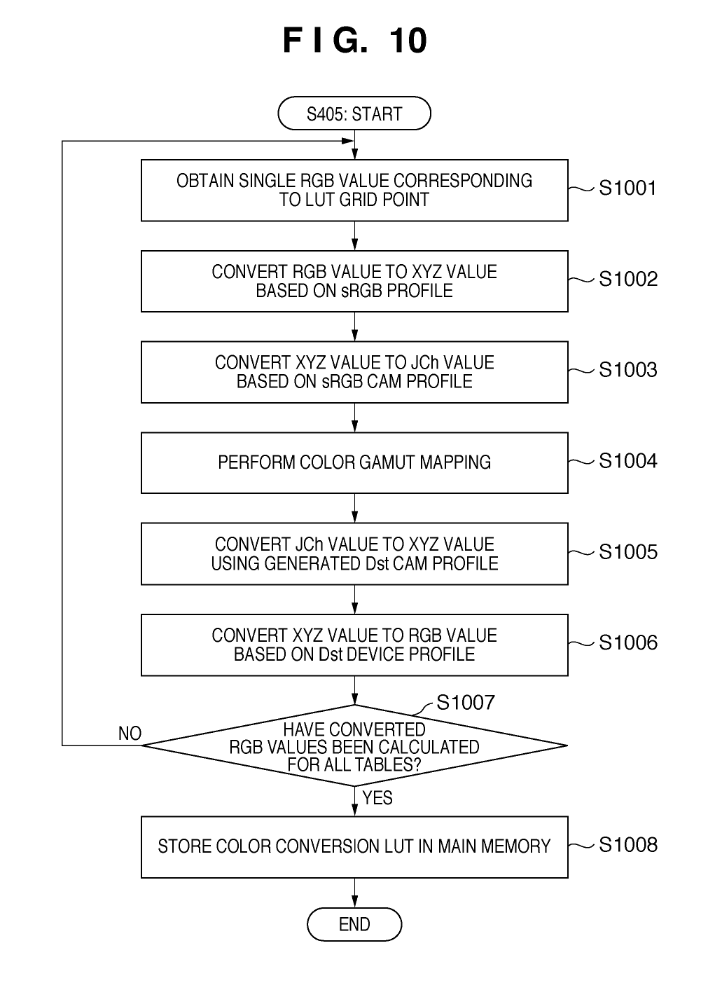

Then, in step S405, a color matching process is carried out using the device profiles and CAM profiles obtained up to step S404, thereby generating a 3D-LUT. Details of the 3D-LUT generation through this color matching process shall be described later using FIG. 10.

Finally, in step S406, the 3D-LUT generated in step S405 is set in the liquid crystal projector 106 as the 3D-LUT 311.

Dst CAM Profile Creation Process

The process for creating the Dst CAM profile, indicated in step S403, shall be described hereinafter using the flowchart in FIG. 7. Here, the Dst CAM profile is generated in LUT format as described above in order to control adaptive whites in accordance with the Y value in XYZ and obtain the correspondence between XYZ values and CIECAM02 color space coordinates.

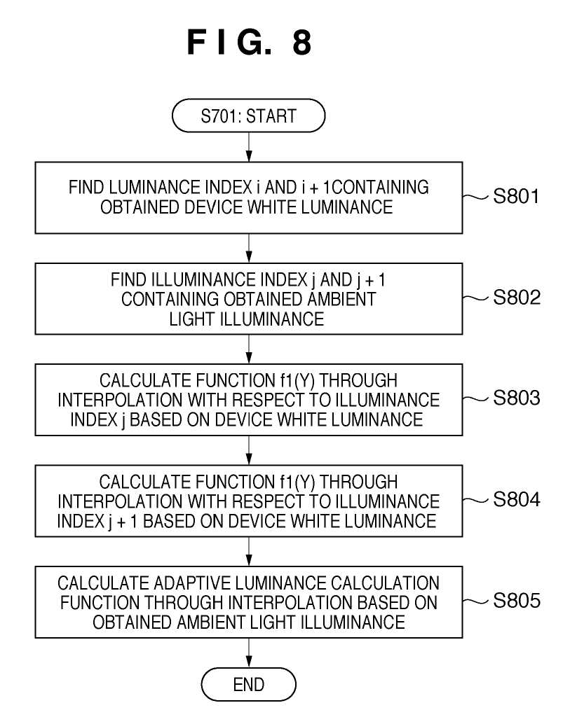

First, in step S701, an adaptive luminance function for calculating the adaptive luminance from the Y value is created based on the device white luminance described in the Dst device profile obtained in step S401 and the ambient light illuminance obtained in step S402. Note that the process for creating this function shall be described in detail later using FIG. 8.

Next, in step S702, the chromaticity of a partial adaptation point is calculated from the ambient light chromaticity and the device white chromaticity described in the Dst device profile. Here, assuming that the device white point of the liquid crystal projector 106 is, in xy coordinates, wd(xd, yd), and the ambient light chromaticity is wl(xl, yl), an internal division point wa(xa, ya) based on a predetermined internal division ratio between wd and wl is taken as the partial adaptation chromaticity. Note that this internal division ratio may be fixed, or may fluctuate based on the luminance and illuminance.

Then, in step S703, a single XYZ value corresponding to LUT grid points in the Dst CAM profile is obtained according to an appropriate procedure.

Next, in step S704, an adaptive white luminance Ya is obtained by inputting the Y value of the XYZ value obtained in step S703 into the adaptive luminance function obtained in step S701.

Then, in step S705, the XYZ value of the adapting white point is calculated from the partial adaptation chromaticity wa(xa, ya) calculated in step S702 and the adaptive white luminance Ya calculated in step S704. Here, the X value Xa and the Z value Za of the adapting white point are calculated as follows.

Xa=Ya·(xa/ya)

Za=Ya·{(1−xa−ya)/ya}

Next, in step S706, the XYZ value obtained in step S703 is converted into a JCh value using the CIECAM02 issued by the CIE. With respect to the appearance parameters for this conversion, the XYZ value calculated in step S705 is used as the adaptive white, and standard values recommended by the CIE are used as the other parameters.

In step S707, it is determined whether or not the conversion has been performed on all LUT grid points; if the conversion has ended, the process advances to step S708, and the generated Dst CAM profile is saved in the main memory 102. On the other hand, if the conversion has not ended, the process returns to step S703.

As described thus far, in step S403, the Dst CAM profile is created through the process illustrated in FIG. 7 as an LUT expressing the correspondence relationship between device-independent color space coordinate values (XYZ) and uniform color space coordinate values (JCh).

Process for Creating Adaptive Luminance Function

The process for creating the adaptive luminance function carried out in step S701 as described above shall be described hereinafter using the flowchart in FIG. 8.

This creation process is performed by interpolating a function f_{i,j}(Y) set in advance for representative conditions based on the device white luminance described in the Dst device profile and the ambient light illuminance. Note that i is an index for the device white luminance, and j is an index for the ambient light illuminance.

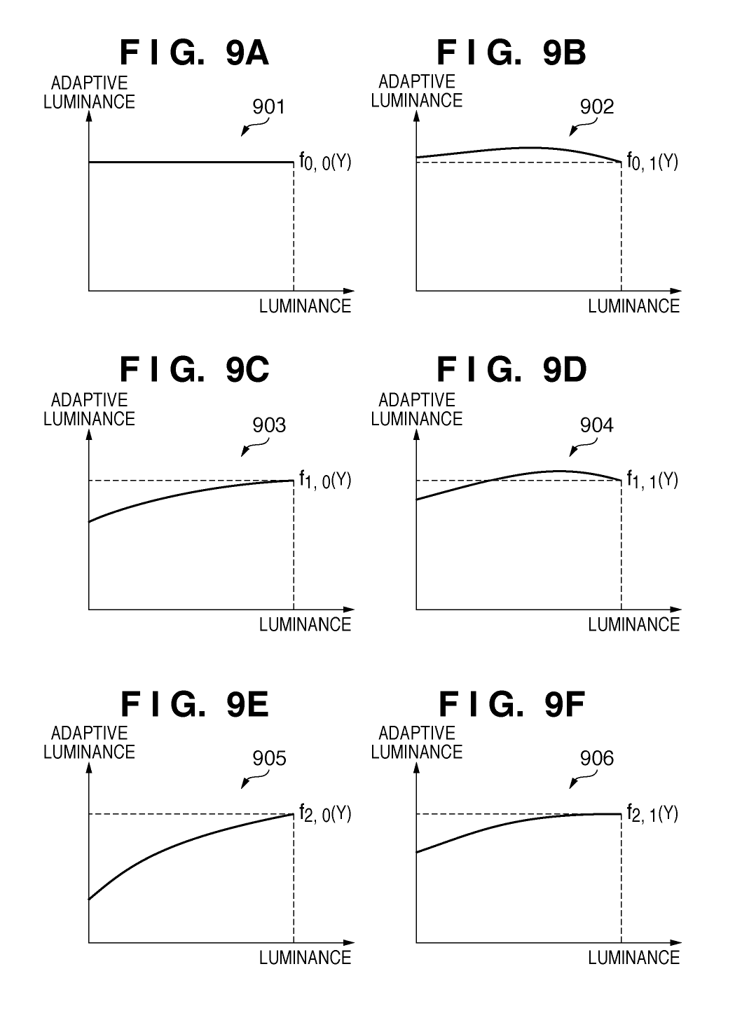

Here, the interpolation method for the function f_{i,j}(Y) shall be described using FIGS. 9A through 9F. FIGS. 9A through 9F illustrate six luminance calculation functions 901 to 906, for representative environments having three types of device white luminances and two types of ambient light illuminances. In FIGS. 9A to 9F, the luminance calculation functions 901 and 902, in which the device white luminance index i=0, correspond to device white luminances of 80 cd/m2. Similarly, the luminance calculation functions 903 and 904, in which i=1, correspond to a device white luminance of 300 cd/m2, and the luminance calculation functions 905 and 906, in which i=2, correspond to a device white luminance of 1000 cd/m2. Furthermore, the luminance calculation functions 901, 903, and 905, in which the ambient light illuminance index j=0, correspond to an ambient light illuminance of 01x, whereas the luminance calculation functions 902, 904, and 906, in which j=1, correspond to an ambient light illuminance of 6001x. In the present embodiment, the adaptive luminance function is created by performing interpolation based on the six luminance calculation functions 901 to 906.

First, in step S801, the luminance index i, containing the obtained device white luminance, and i+1 are obtained. For example, in the case where the obtained device white luminance is 800 cd/m2, and the environment is a representative environment as indicated in FIGS. 9A to 9F, the luminance index containing the device white luminance is i=1, i+1=2. Note that if a luminance index that includes the device white luminance cannot be determined, the index of the closest luminance is set for both. For example, in the case where the obtained device white luminance is 1500 cd/m2, and the environment is a representative environment as shown in FIGS. 9A to 9F, the luminance index i and i+1 are both set to 2.

Next, in step S802, the illuminance index j, containing the obtained ambient light illuminance, and j+1 are obtained. For example, in the case where the obtained ambient light illuminance is 3001x, and the environment is a representative environment as indicated in FIGS. 9A to 9F, the illuminance index containing that ambient light illuminance is j=0, j+1=1. Note that if an illuminance index that contains the ambient light illuminance cannot be determined, the index of the closest illuminance is set for both. For example, in the case where the obtained ambient light illuminance is 10001x, and the environment is a representative environment as indicated in FIGS. 9A to 9F, the illuminance index j and j+1 are both set to 1.

Then, in step S803, a function f₁(Y) for the illuminance index j is calculated through interpolation as indicated by the following Equation (1) based on the device white luminance. Note that the coefficient α in Equation (1) may be calculated so that the interpolation performed using that equation is linear interpolation with respect to the luminance, or may be calculated so that the interpolation is nonlinear interpolation.

f₁(Y)=αf_{i,j}(Y)+(1−α)f_{i+1,j}(Y) (1)

Then, in step S804, a function f₂(Y) for the illuminance index j+1 is calculated through interpolation as indicated by the following Equation 2 based on the device white luminance, in the same manner as in step S803. Note that the value used in step S803 is used as the coefficient α in Equation (2).

f₂(Y)=αf_{i,j+1}(Y)+(1−α)f_{1+1,j+1}(Y) (2)

Next, in step S805, the adaptive luminance calculation function f(Y) is calculated through the interpolation indicated by the following Equation (3) based on the ambient light illuminance. Note that the coefficient β in Equation (3) may be calculated so that the interpolation performed using that equation is linear interpolation with respect to the illuminance, or may be calculated so that the interpolation is nonlinear interpolation.

f(Y)=βf₁(Y)+(1−β)f₂(Y) (3)

As described thus far, in step S701, the adaptive luminance function f(Y) is created through the process illustrated in FIG. 8.

3D-LUT Creation Through Color Matching

Hereinafter, the process for creating the 3D-LUT 311 through color matching, performed in the aforementioned step S405, shall be described in detail using the flowchart in FIG. 10.

First, in step S1001, a single RGB value corresponding to an LUT grid point is obtained in accordance with an appropriate procedure.

Then, in step S1002, the RGB value obtained in step S1001 is converted into an XYZ value based on the sRGB device profile obtained in step S404.

Next, in step S1003, the XYZ value calculated in step S1002 is converted into a JCh value based on the CIECAM02 issued by the CIE. Note that the sRGB CAM profile obtained in step S404 is used as the appearance parameters here.

Then, in step S1004, color gamut mapping is performed based on the sRGB source color gamut and the liquid crystal projector 106 destination color gamut. In other words, color gamut control is performed whereby colors in the source color gamut that correspond to colors in the destination color gamut are not converted, and colors that correspond to colors outside of the destination color gamut are mapped to the destination color gamut surface to which the distance is minimum. Note that it is assumed that the source color gamut and the destination color gamut have been calculated in advance, prior to this process.

Then, in step S1005, the JCh value on which the color gamut mapping was performed in step S1004 is converted into an XYZ value using the Dst CAM profile calculated in step S403.

Next, in step S1006, the XYZ value calculated in step S1005 is converted into an RGB value based on the Dst device profile obtained in step S401.

Then, in step S1007, it is determined whether or not the conversion has been performed on all LUT grid points; if the conversion has ended, the process advances to step S1008, and the calculated 3D-LUT is saved in the main memory 102. On the other hand, if the conversion has not ended, the process returns to step S1001.

As described thus far, in step S405, the 3D-LUT 311 is generated through color matching using the process illustrated in FIG. 10.

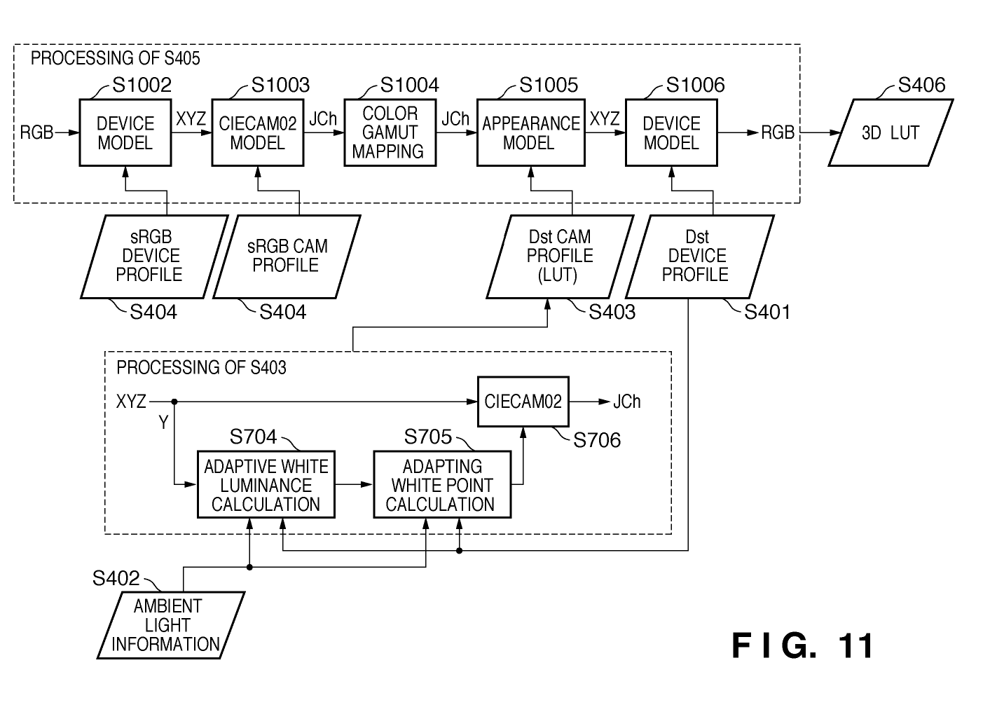

In the present embodiment, the 3D-LUT 311 referenced by the color correction processing circuit 304 is generated in accordance with the flowchart of FIG. 4, as described above. Here, an outline of the 3D-LUT 311 generation as described above is illustrated as a schematic block diagram in FIG. 11. In FIG. 11, each process and data is assigned the step number (for data, the step number of the process for obtaining that data) in the flowchart corresponding thereto.

According to FIG. 11, color matching is performed in step S405 in order to generate the color correction 3D-LUT 311 for the liquid crystal projector 106. In other words, first, a first conversion (RGB to JCh) is performed on the source side based on the sRGB device profile and the sRGB CAM profile, and then color gamut mapping is performed in a uniform color space. Then, a second conversion (JCh to RGB) is performed on the destination side based on the Dst CAM profile and Dst device profile corresponding to the liquid crystal projector 106. At this time, in step S403, the Dst CAM profile is created in advance based on ambient light information and the Dst device profile.

As described thus far, according to the present embodiment, the appearance of colors in an sRGB monitor is faithfully reproduced in the liquid crystal projector 106 by calculating the adaptive luminance based on the device white luminance and ambient light illuminance of the liquid crystal projector 106, and controlling the color space conversion. In other words, color reproduction that matches the senses of brightness can be performed among devices having luminance ranges that differ greatly and among environments that have illuminances that differ greatly, as is the case with sRGB monitors and liquid crystal projectors.

Furthermore, by controlling the color space conversion through color matching, it is possible to achieve both the faithful reproduction of color appearance and the faithful reproduction of the sense of brightness.

Further still, the present embodiment performs color space conversion using an LUT, which generally has a low processing cost and enables high-speed processing, and is therefore particularly useful when high-speed real-time conversion is necessary, as with displays.

As a further additional effect, it is possible to control appearance parameters as the observation conditions, and therefore it is possible to improve the reproducibility of color appearance by applying partial adaptation techniques, even under complex observation conditions such as when multiple devices are observed simultaneously.

As described thus far, according to the present embodiment, the appearance of an sRGB monitor is faithfully reproduced in the liquid crystal projector 106 when converting an image signal for the sRGB monitor, serving as a first device, to an image signal for the liquid crystal projector 106, serving as a second device.

### Second Embodiment

Next, a second embodiment of the present invention shall be described.

The aforementioned first embodiment illustrated an example in which LUT descriptions can be applied to a Dst CAM profile. However, in a case such as where a color management application to which LUT descriptions cannot be applied has been introduced into the Dst CAM profile, it is not possible to apply the aforementioned first embodiment. Accordingly, by modifying the descriptions of the Dst device profile, the second embodiment makes it possible to obtain the same effects as the aforementioned first embodiment even in cases where LUT descriptions cannot be applied to the Dst CAM profile. Hereinafter, descriptions shall be provided particularly regarding the portions that differ from the first embodiment.

3D-LUT Generation Process

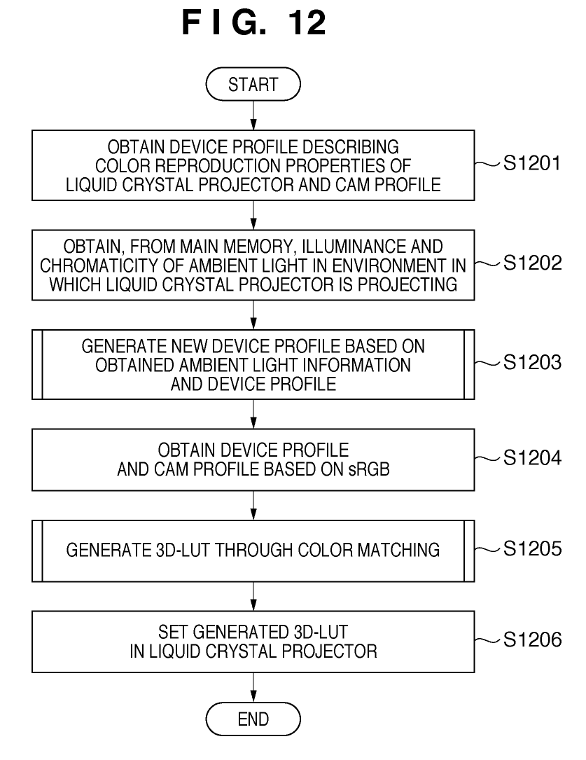

The process for generating the 3D-LUT 311 referenced by the color correction processing circuit 304 within the liquid crystal projector 106 in the second embodiment follows the flowchart of FIG. 12 rather than FIG. 4 of the aforementioned first embodiment.

First, in step S1201, the device profile describing the Dst device color reproduction properties of the liquid crystal projector 106, specified by the user, is obtained. Similarly, the liquid crystal projector 106 Dst CAM profile is obtained. The obtainment of these profiles is, as in step S401 in the first embodiment, carried out by the user making a selection through a pull-down list or the like in a window.

Next, in step S1202, the illuminance and chromaticity of the ambient light in the environment in which the liquid crystal projector is projecting, stored in the main memory 102, are obtained.

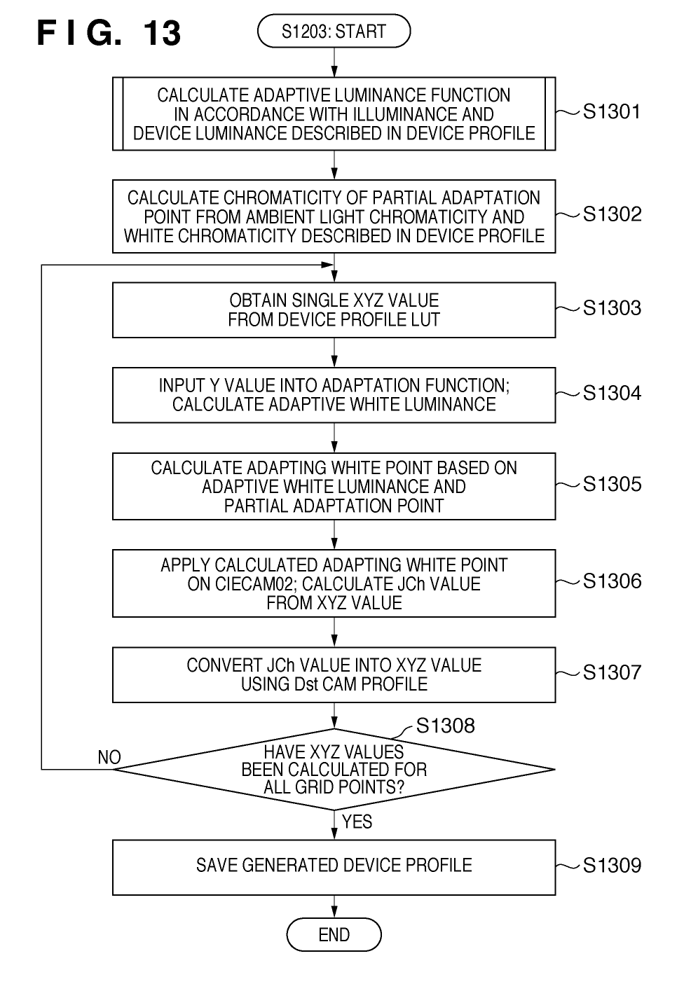

Then, in step S1203, a new Dst device profile is generated based on the Dst device profile information obtained in step S1201 and the observed light information obtained in step S1202. Note that the process for generating the Dst device profile shall be described in detail using FIG. 13.

Then, in step S1204, a device profile based on sRGB and a CAM profile based on sRGB are obtained.

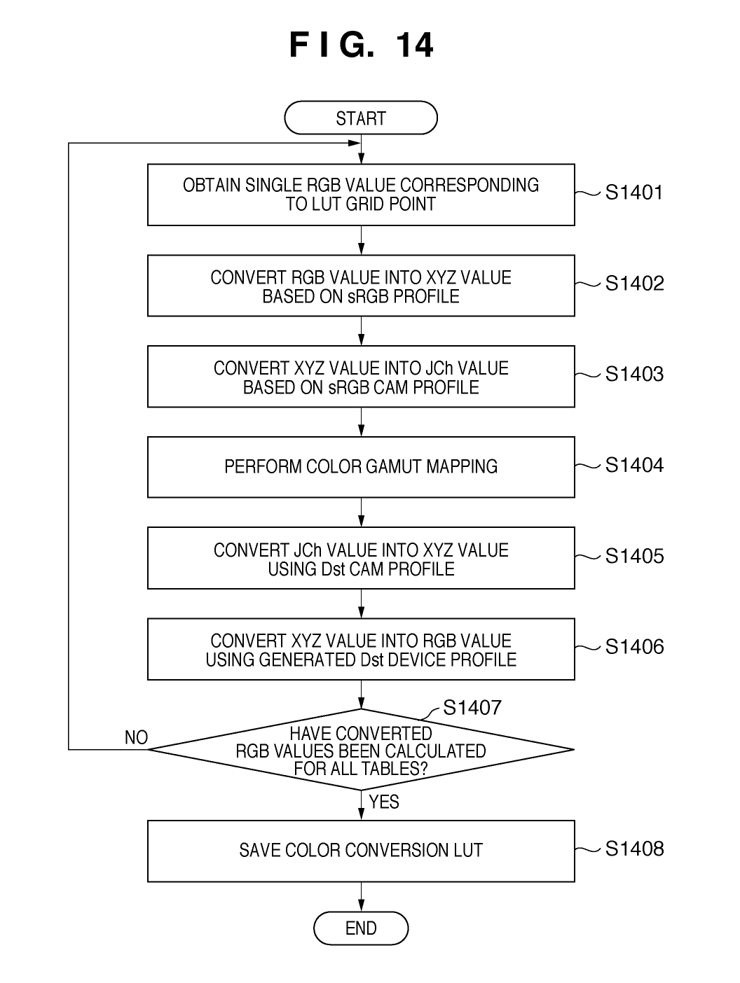

Then, in step S1205, a color matching process is carried out using the device profiles and CAM profiles obtained or generated up to step S1204, thereby generating a 3D-LUT. Details of the 3D-LUT generation through this color matching process shall be described later using FIG. 14.

Finally, in step S1206, the 3D-LUT generated in step S1205 is set in the liquid crystal projector 106 as the 3D-LUT 311.

Process for Creating Dst Device Profile

The process for creating the new Dst device profile, indicated in step S1203, shall be described hereinafter using the flowchart in FIG. 13.

First, in step S1301, an adaptive luminance function for calculating the adaptive luminance from a Y value is calculated based on the device white luminance described in the Dst device profile obtained in step S1201 and the ambient light illuminance obtained in step S1202. Note that the details of the process for calculating this adaptive luminance function are as indicated in the flowchart of FIG. 8, as in the aforementioned first embodiment.

Next, in step S1302, the chromaticity of a partial adaptation point is calculated from the ambient light chromaticity and the device white chromaticity described in the Dst device profile. Here, assuming that the device white point of the liquid crystal projector 106 is, in xy coordinates, wd(xd, yd), and the ambient light chromaticity is wl(xl, yl), an internal division point wa(xa, ya) based on a predetermined internal division ratio between wd and wl is taken as the partial adaptation chromaticity. Note that this internal division ratio may be fixed, or may fluctuate based on the luminance and illuminance.

Next, in step S1303, a single XYZ value in the LUT of the Dst device profile is obtained according to an appropriate procedure.

Next, in step S1304, an adaptive white luminance Ya is obtained by inputting the Y value of the XYZ values obtained in step S1303 into the adaptive luminance function obtained in step S1301.

Then, in step S1305, the XYZ value of the adapting white point is calculated from the partial adaptation chromaticity wa calculated in step S1302 and the adaptive white luminance Ya calculated in step S1304. Here, the X value Xa and the Z value Za of the adapting white point are calculated as follows.

Xa=Ya·(xa/ya)

Za=Ya·{(1−xa−ya)/ya}

Next, in step S1306, the XYZ value obtained in step S1303 is converted into a JCh value using the CIECAM02. With respect to the appearance parameters for this conversion, the XYZ value calculated in step S1305 is used as the adaptive white, and standard values recommended by the CIE are used as the other parameters.

Then, in step S1307, the Jch value obtained in step S1306 is converted into an XYZ value based on the Dst CAM profile obtained in step S1201. At this time, the XYZ value of the original DST device profile is replaced with the new XYZ value resulting from this conversion, and is thus updated.

Then, in step S1308, it is determined whether or not the conversion has been performed on all LUT grid points; if the conversion has ended, the process advances to step S1309, and the generated Dst device profile is saved in the main memory 102. On the other hand, if the conversion has not ended, the process returns to step S1303.

As described thus far, in step S1203, a new Dst device profile is created as an LUT expressing the correspondence relationship between device-dependent color space coordinate values (RGB) and device-independent color space coordinate values (XYZ) through the process illustrated in FIG. 13.

3D-LUT Creation Through Color Matching

Hereinafter, the process for creating a 3D-LUT through color matching, performed in the aforementioned step S1205, shall be described in detail using the flowchart in FIG. 14.

First, in step S1401, a single RGB value corresponding to an LUT grid point is obtained in accordance with an appropriate procedure.

Then, in step S1402, the RGB value obtained in step S1401 is converted to an XYZ value based on the sRGB device profile obtained in step S1204.

Next, in step S1403, the XYZ value calculated in step S1402 is converted into a JCh value based on the CIECAM02. Note that the sRGB CAM profile obtained in step S1204 is used as the appearance parameters here.

Then, in step S1404, color gamut mapping is performed based on the sRGB source color gamut and the liquid crystal projector 106 destination color gamut. In other words, color gamut control is performed whereby colors in the source color gamut that correspond to colors in the destination color gamut are not converted, and colors that correspond to colors outside of the destination color gamut are mapped to the destination color gamut surface to which the distance is minimum. Note that it is assumed that the source color gamut and the destination color gamut have been calculated in advance, prior to this process.

Then, in step S1405, the JCh value on which the color gamut mapping was performed in step S1404 is converted into an XYZ value using the Dst CAM profile calculated in step S1201.

Next, in step S1406, the XYZ value calculated in step S1405 is converted into an RGB value based on the Dst device profile generated in step S1203.

Then, in step S1407, it is determined whether or not the conversion has been performed on all LUT grid points; if the conversion has ended, the process advances to step S1408, and the calculated 3D-LUT is saved in the main memory 102. On the other hand, if the conversion has not ended, the process returns to step S1401.

As described thus far, in step S1205, a 3D-LUT is generated through color matching using the process illustrated in FIG. 14.

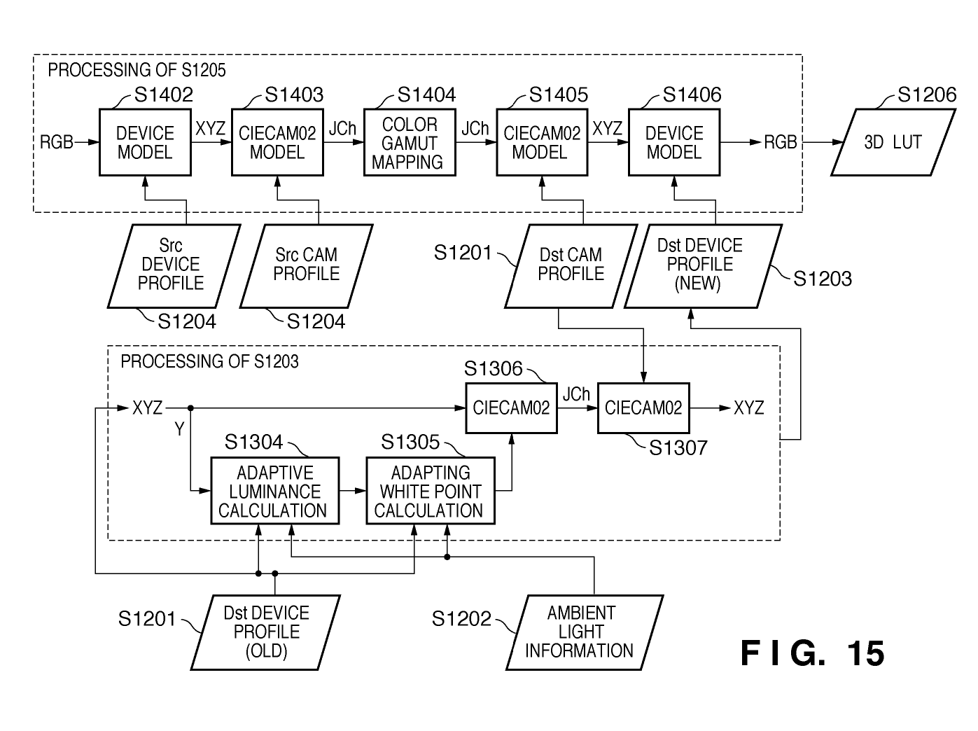

In the second embodiment, a 3D-LUT referenced by the color correction processing circuit 304 is generated in accordance with the flowchart of FIG. 12, as described above. Here, an outline of the 3D-LUT generation of the second embodiment as described above is illustrated as a schematic block diagram in FIG. 15. In FIG. 15, each process and data is assigned the step number (for data, the step number of the process for obtaining that data) in the flowchart corresponding thereto.

According to FIG. 15, color matching is performed in step S1205 in order to generate the color correction 3D-LUT 311 for the liquid crystal projector 106. In other words, first, a first conversion (RGB to JCh) is performed on the source side based on the sRGB device profile and the sRGB CAM profile, and then color gamut mapping is performed in a uniform color space. Then, a second conversion (JCh to RGB) is performed on the destination side based on the Dst CAM profile and Dst device profile corresponding to the liquid crystal projector 106. At this time, in step S1203, a Dst device profile is newly created based on the ambient light information and the original Dst device profile.

As described thus far, according to the second embodiment, the same effects as in the aforementioned first embodiment are obtained by modifying the descriptions of the Dst device profile, without creating an LUT as a Dst CAM profile.

### Third Embodiment

Next, a third embodiment of the present invention shall be described.

In the aforementioned first and second embodiments, an example was described in which color space coordinate value conversion is controlled by calculating an adaptive luminance based on the device white luminance and ambient light illuminance in the destination, thereby faithfully reproducing the appearance of an sRGB monitor in a liquid crystal projector. Conversely, the third embodiment aims to faithfully reproduce the appearance of a liquid crystal projector in an sRGB monitor. To achieve this, the color space coordinate value conversion based on device white luminance and ambient light illuminance described in the first and second embodiments as being performed in the destination is, in the third embodiment, applied to the source.

Apparatus Configuration

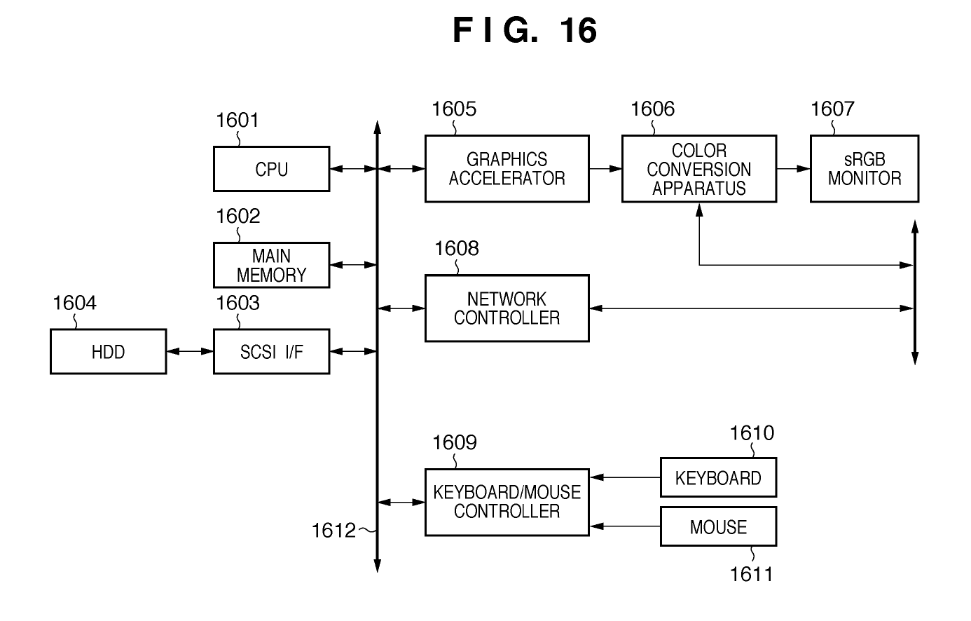

FIG. 16 is a block diagram illustrating the configuration of a color processing apparatus according to the third embodiment. The color processing apparatus illustrated in FIG. 16 according to the present embodiment is configured of what is known as a computer system, and image display software is executed thereby. The operations of this image display software shall be described hereinafter.

In FIG. 16, 1601 represents a CPU that controls the overall processing of the apparatus, and 1602 represents a main memory used as a work area of the CPU 1601 and as a storage region. 1604 represents a hard disk drive (HDD), which is connected to a PCI bus 1612 via a SCSI I/F 1603. Hereinafter, the hard disk drive, including an installed HD, shall be called an HDD 1604. 1605 is a graphics accelerator, which controls the output of an image that is to be displayed in an sRGB monitor 1607 to a color conversion apparatus 1606. The color conversion apparatus 1606 performs color correction on the image inputted from the graphics accelerator 1605 by referring to a 3D-LUT, so that the appearance of the image in a liquid crystal projector, not shown, is faithfully reproduced when the image is displayed in the sRGB monitor 1607. Note that the color conversion apparatus 1606 is connected to a local area network (LAN) 1613. 1608 is a network controller, and controls the connection between a PCI bus 1612 and the LAN 1613. 1610 is a keyboard and 1611 is a mouse, which are connected to the PCI bus 1612 via a keyboard/mouse controller 1609.

In the configuration illustrated in FIG. 16, first, image display software stored in the HDD 1604 is executed through processing performed by the CPU 1601. Then, in the event of a user instruction, a JPEG image, an H.264 image, or the like stored in the HDD 1604 is loaded, and the image signal thereof is inputted into the color conversion apparatus 1606 via the graphics accelerator 1605, through processing performed by the CPU 1601. After color conversion based on a 3D-LUT is performed by the color conversion apparatus 1606 on the inputted image signal, the post-color conversion image is displayed in the sRGB monitor 1607. In the third embodiment, the appearance of the same image as projected by a specific liquid crystal projector (not shown) is faithfully reproduced in the appearance of the displayed image in the sRGB monitor 1607 observed by the user.

In the third embodiment, it is necessary for the user to set an appropriate 3D-LUT in the color conversion apparatus 1606 in advance in order to ensure that the displayed image of the sRGB monitor 1607 is appropriate, or in other words, in order to faithfully reproduce the appearance of the image as projected by a specific liquid crystal projector. Hereinafter, in the third embodiment, the specific liquid crystal projector whose image appearance is to be reproduced in the sRGB monitor 1607 shall be referred to simply as a “liquid crystal projector”.

Hereinafter, the setting of a 3D-LUT in the color conversion apparatus 1606 shall be described using FIG. 16. In the configuration illustrated in FIG. 16, a 3D-LUT setting application stored in the HDD 1604 is executed by the CPU 1601 in response to a user instruction.

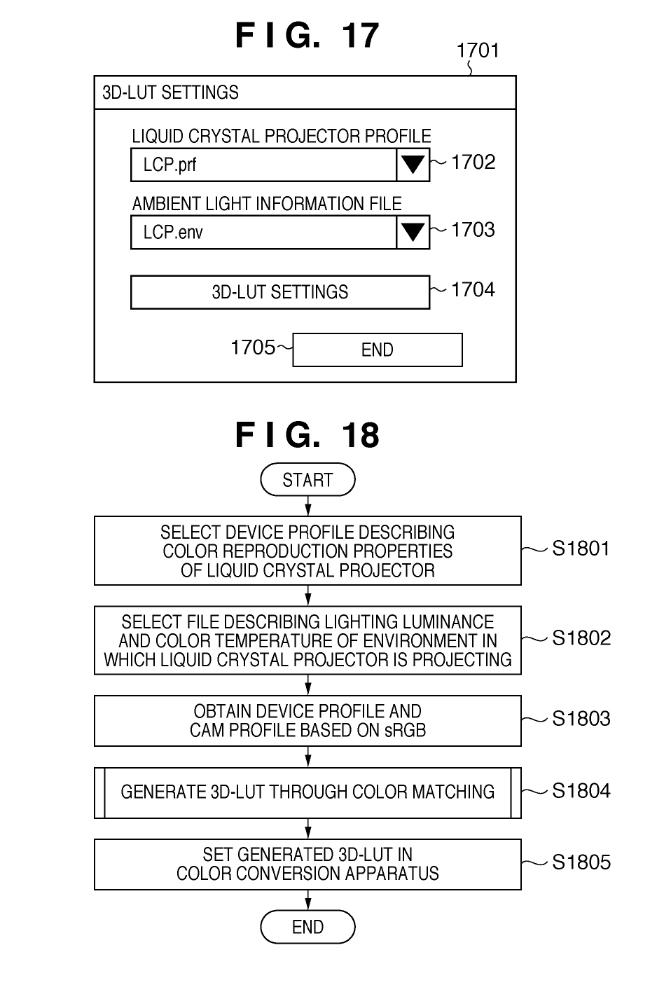

After this, a window 1701 illustrated in FIG. 17 is displayed in the sRGB monitor 1607 via the graphics accelerator 1605 and the color conversion apparatus 1606 based on an application window rendering command from the CPU 1601. In this window 1701, the user specifies a device profile describing the device color reproduction properties of a specific liquid crystal projector using a pull-down list 1702. The user furthermore specifies, using a pull-down list 1703, an ambient light information file in which is described ambient light information of the location in which the liquid crystal projector is installed. Note that this ambient light information file should be generated in advance based on measurement results obtained by a chroma illuminometer; the illuminance and chromaticity of the ambient light are described in this file. Next, when the user presses a 3D-LUT setting button 1704, a color correction 3D-LUT is generated in accordance with the flowchart shown in FIG. 18, described later, and is set in the color conversion apparatus 1606 via the network controller 1608 and the LAN 1613.

3D-LUT Generation Process

Hereinafter, the process for generating the 3D-LUT that is set in the color conversion apparatus 1606 in the third embodiment shall be described using the flowchart shown in FIG. 18.

First, in step S1801, the device profile describing the device color reproduction properties of the liquid crystal projector, specified by the user through the pull-down list 1702 in the window 1701 shown in FIG. 17, is obtained.

Then, in step S1802, the illuminance and chromaticity of the ambient light in the environment in which the liquid crystal projector is projecting, specified by the user through the pull-down list 1703 of the window 1701, are obtained.

Next, in step S1803, the device profile and CAM profile of the sRGB monitor 1607 are obtained.

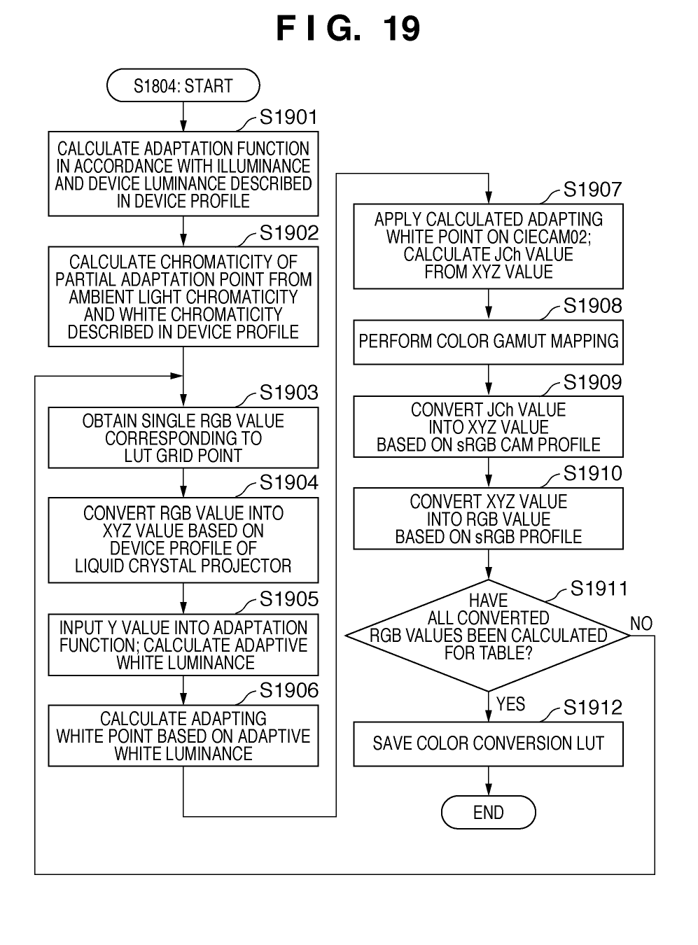

Then, in step S1804, a color matching process is carried out using the device profiles and CAM profiles obtained up to step S1803, thereby generating a 3D-LUT. Details of the 3D-LUT generation through this color matching process shall be described later using FIG. 19.

Finally, in step S1805, the 3D-LUT generated in step S1804 is set in the color conversion apparatus 1606.

3D-LUT Creation Through Color Matching

Hereinafter, the process for creating a 3D-LUT through color matching, performed in the aforementioned step S1804, shall be described in detail using the flowchart in FIG. 19.

First, in step S1901, an adaptive luminance function for calculating the adaptive luminance from a Y value is calculated based on the device white luminance described in the device profile of the liquid crystal projector obtained in step S1801 and the ambient light illuminance obtained in step S1802. Note that this process for calculating the adaptive luminance function is the same as that illustrated in the flowchart of FIG. 8 in the aforementioned first embodiment.

Next, in step S1902, the chromaticity of a partial adaptation point is calculated from the ambient light chromaticity and the device white chromaticity described in the device profile. Here, assuming that the device white point of the liquid crystal projector is, in xy coordinates, wd(xd, yd), and the ambient light chromaticity is wl(xl, yl), an internal division point wa(xa, ya) based on a predetermined internal division ratio between wd and wl is taken as the partial adaptation chromaticity. Note that this internal division ratio may be fixed, or may fluctuate based on the luminance and illuminance.

Then, in step S1903, a single RGB value corresponding to an LUT grid point is obtained in accordance with an appropriate procedure.

Next, in step S1904, the RGB value obtained in step S1903 is converted to an XYZ value based on the liquid crystal projector device profile obtained in step S1801.

Next, in step S1905, an adaptive white luminance Ya is obtained by inputting the Y value of the XYZ values obtained in step S1904 into the adaptive luminance function obtained in step S1901.

Then, in step S1906, the XYZ value of the adapting white point is calculated from the partial adaptation chromaticity wa calculated in step S1902 and the adaptive white luminance Ya calculated in step S1905. Here, the X value Xa and the Z value Za of the adapting white point are calculated as follows.

Xa=Ya·(xa/ya)

Za=Ya·{(1−xa−ya)/ya}

Next, in step S1907, the XYZ value obtained in step S1904 is converted into a JCh value using the CIECAM02. With respect to the appearance parameters for this conversion, the XYZ value calculated in step S1906 is used as the adaptive white, and standard values recommended by the CIE are used as the other parameters.

Then, in step S1908, color gamut mapping is performed based on the liquid crystal projector source color gamut and the sRGB monitor 1607 destination color gamut. In other words, color gamut control is performed whereby colors in the source color gamut that correspond to colors in the destination color gamut are not converted, and colors that correspond to colors outside of the destination color gamut are mapped to the destination color gamut surface to which the distance is minimum. Note that it is assumed that the source color gamut and the destination color gamut have been calculated in advance, prior to this process.

Then, in step S1909, the JCh value on which the color gamut mapping was performed in step S1908 is converted into an XYZ value using the sRGB monitor 1607 CAM profile obtained in step S1803.

Next, in step S1910, the XYZ value calculated in step S1909 is converted into an RGB value based on the sRGB monitor 1607 device profile obtained in step S1803.

Then, in step S1911, it is determined whether or not the conversion has been performed on all LUT grid points; if the conversion has ended, the process advances to step S1912, and the calculated 3D-LUT is saved in the main memory 102. On the other hand, if the conversion has not ended, the process returns to step S1903.

As described thus far, in step S1804, a 3D-LUT is generated through color matching using the process illustrated in FIG. 19.

As described thus far, according to the third embodiment, color space conversion based on the device white luminance and the ambient light illuminance of the destination, as described in the aforementioned first and second embodiments, is applied to the source. Through this, the appearance in, for example, a liquid crystal projector serving as a first device can be faithfully reproduced in an sRGB monitor serving as a second device.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-287947, filed Nov. 10, 2008, which is hereby incorporated by reference herein in its entirety.

What is claimed is:

1. A color processing apparatus that creates a lookup table for performing a conversion process corresponding to ambient light, the apparatus comprising:
an obtainment unit configured to obtain the illuminance of the ambient light and the device luminance of a destination device;
a creation unit configured to create an adaptive luminance function from the illuminance of the ambient light and the device luminance;
a setting unit configured to set an adaptive white luminance from a luminance value of grid point color data corresponding to a grid point in the lookup table, using the adaptive luminance function;
a conversion unit configured to perform a conversion process on the grid point color data in accordance with a color appearance model, using the adaptive white luminance; and
a saving unit configured to save the converted color data in the lookup table.

2. The color processing apparatus according to claim 1,
wherein the obtainment unit further obtains the chromaticity of the ambient light and the device chromaticity;
the apparatus further comprises a calculation unit configured to calculate a partial adaptation chromaticity from the ambient light chromaticity and the device chromaticity; and
the conversion unit performs a conversion process on inputted color data in accordance with a color appearance model, using the adaptive white luminance and the partial adaptation chromaticity.

3. The color processing apparatus according to claim 1, further comprising:
a first conversion unit configured to convert inputted color data into first color data using a source profile;
a second conversion unit configured to perform a source color appearance conversion on the first color data, thereby outputting second color data;
a third conversion unit configured to convert the second color data into third color data by performing gamut mapping using a source gamut and a destination gamut, thereby outputting the third color data;
a fourth conversion unit configured to convert the third color data into fourth color data using the lookup table; and
a fifth conversion unit configured to convert the fourth color data into fifth color data using a profile of the destination device.

4. A color processing method performed by a color processing apparatus that creates a lookup table for performing a color appearance conversion process corresponding to ambient light, the method comprising:
an obtainment step of obtaining the illuminance of the ambient light and the device luminance of a destination device;
a creation step of creating an adaptive luminance function from the illuminance of the ambient light and the device luminance;
a setting step of setting an adaptive white luminance from a luminance value of grid point color data corresponding to a grid point in the lookup table, using the adaptive luminance function;
a conversion step of performing a conversion process on the grid point color data in accordance with a color appearance model, using the adaptive white luminance; and
a saving step of saving the converted color data in the lookup table.

5. A computer-readable storage medium in which is stored a computer program for causing a computer to function as the units of the color processing apparatus according to claim 1.
